(19) United States
(12) Patent Application Publication
(10) Pub. No.: US 2006/0048070 A1
(43) Pub. Date: Mar. 2, 2006

(54) Operator interface system for a touch screen device

(75) Inventors: William Richard Taylor, Thornhill (CA); Richard George Taylor, East Aurora, NY (US); James C. McClocklin, Richmond Hill (CA)

Correspondence Address: SIMPSON & SIMPSON, PLLC, 5555 MAIN STREET, WILLIAMSVILLE, NY, 14221-5406, US

(73) Assignee: KIP Systems

(21) Appl. No.: 10/932,153

(22) Filed: Sep. 1, 2004

(51) Int. Cl. G06F 17/00

(52) U.S. Cl. 715/773; 715/810; 715/840

(57) ABSTRACT

The invention comprises, in one form thereof, an operator interface system for a touch screen device having a simplified graphic interface. The operator interface system includes a start screen having fewer than five start screen buttons. The touch screen device is generally a kiosk located within a store. A store map screen is linked to one of the start screen buttons and includes several department buttons integrated into a store layout. A products screen is linked to one of the start screen buttons and provides access to information about the plurality of products sold by the store organized into an intuitive hierarchy. A store services screen is linked to one of the start screen buttons and provides access to one or more service description screens.

### FIELD OF THE INVENTION

This invention relates to operator interface systems. More particularly, the invention relates to a graphic user interface for a computer having a touch screen input device, especially of the type used for point-of-sale kiosks.

### BACKGROUND OF THE INVENTION

Conventional in-store customer information kiosks have limited information and can be difficult for a customer to use. Conventional kiosks display an overwhelming amount of information even when a user first starts using the kiosk. Thus, the user is required to spend time reading through extraneous information to find relevant information. Further, conventional kiosks require the user to learn to use the operating system for the kiosk. Alternatively, the user may be required to have prior knowledge of how to use the operating system, such as in the case that the system is modeled after a web browser, which requires the user to be comfortable with a web browser to use the kiosk operating system.

A number of operator interfaces are described in the art for customer information systems and the like. For instance, U.S. Pat. No. 6,587,835 (Treyz, et al.) discloses a hand-held device that provides assistance to shoppers in a shopping mall. The device may provide information on products sold in a store and Treyz discloses an interface for accessing such information. What is needed is a simple, intuitive interface for a customer service device. Treyz necessarily works with a smaller interface than used in a kiosk and thus does not use the same point and touch navigation as would be used by the present invention.

U.S. Pat. No. 6,583,800 (Ridgley, et al.) discloses an interface for information stored in a hierarchy. The interface includes a content area that displays the information in the current level of the hierarchy, an area that shows the parent node, a navigation history area, and an area for the user to collect desired data. The system may be used in conjunction with a touch screen. Ridgley's system attempts to simplify browsing of a hierarchy by giving the user information about the current location in the hierarchy rather than providing a small number of concise choices. Also, Ridgley's system relies on overlays to show the user what parts of the content sub-areas may be actuated to affect the data.

U.S. Pat. No. 6,211,856 (Choi, et al.) discloses an interface for a touch screen that scales icons such that a large number may be displayed on the screen at once. The user may then zoom in on a desired icon such that it is a useable size. While Choi discloses an interface, the ease of use of the system depends upon the user scaling the icons to the desired size. No implicit order is provided and requires the user to go from a comprehensive view to a formal view on their own.

U.S. Pat. No. 5,956,025 (Goulden, et al.) discloses an interface for a home theater remote control having a touch screen. The interface is hierarchically organized with a consistent layout. However, the screens disclosed by Goulden present the user with a large number of choices requiring the user to be familiar with the screens in order to quickly navigate the hierarchy.

U.S. Pat. No. 5,950,173 (Perkowski) discloses a system that includes a list of universal product codes (UPC) for consumer products and a list of internet web site uniform resource locators (URL) associated with each UPC. The web sites provide the user with information about the product associated with that particular UPC. The user accesses the list by entering the UPC number or by scanning the UPC with a UPC reader. However, Perkowski's system only provides information for products registered with the system and for which the user has the UPC. Thus the user is required to obtain a UPC for a particular product prior to getting information on that item from Perkowski's system.

U.S. Pat. No. 5,890,135 (Powell) discloses a system for redeeming coupons. In this system, the user has a card with electronic coupons. The system includes a kiosk that will read the user's card and print a shopping list for the items associated with the electronic coupons on the card. However, product information is limited to the information on the electronic coupon and the shopping list is limited to the items for which the customer has a coupon. The customer is not provided with a way to browse and search for product information not on the coupon card.

U.S. Pat. No. 5,887,271 (Powell) discloses a system for redeeming coupons. In this system, the user has a card with electronic coupons. The system includes a kiosk that will read the user's card and display a map of the store that indicates where the products associated with the electronic coupons are located within the store. However, product information is limited to the information on the electronic coupon. The customer is not provided with a way to browse and search for product information not on the coupon card.

U.S. Pat. No. 5,765,142 (Allred, et al.) discloses a developer's tool for developing software to manage the marketing of a product. The tool can be used to develop a dynamic interface for a vending machine or a kiosk. The dynamic interface can be modified according to marketing information.

U.S. Pat. No. 5,734,719 (Tsevdos, et al.) discloses a touch screen kiosk that allows the user to search and preview audio and video content in a database. However, Tsevdos' system is limited to the search, preview, and purchase of remotely stored digitized information such as audio and video. Thus the types of products a user may search for are limited, whereas a user interface that is versatile and can show relationships between different types of products is needed. Further, Tsevdos' system does not disclose a map for displaying product locations within a store.

U.S. Pat. No. 5,295,062 (Fukushima) discloses a touch screen interface that displays detailed information in a pull-down operation.

Such conventional systems are not intuitive, they require the user to sift through irrelevant information, and/or they only provide the user with a fraction of the information needed to make an informed purchasing decision.

Therefore, an operator interface for a customer information system that is intuitive to use is desired in the art.

Further, an operator interface for a customer information system that doesn't overwhelm the user with information is desired in the art.

Even further, an operator interface that provides the user with adequate information to make a purchase decision is desired in the art.

Still further, an operator interface that provides useful information such as product location, special prices, products related to a chosen product, and shopping lists is desired in the art.

### SUMMARY OF THE INVENTION

The present invention relates to automated sales support systems and their user interfaces. As retail sales have evolved with time, the ability to train salespeople to provide customers with useful product information has effectively decreased. The great increase in the number of types of products and the decreasing number of salespeople have lessened the effective information a customer can get in the retail environment. The existence of a system with a highly navigable interface so that a customer can access product information is highly desirable. Such an interface allows customers in a store to more effectively browse and search through the myriad product and service choices in real time.

The invention comprises, in one form thereof, a touch screen operator interface for an in-store customer information system. The operator interface system includes a start screen that has a small number of start screen buttons. A products screen is linked to one of the start screen buttons. The products screen provides access to a product hierarchy and a projects hierarchy. The product hierarchy organizes the products carried by the store into a list of departments. Each of the departments is divided into categories and a user may further filter the product list in a category by manufacturer. The products screen also allows the user to filter the product hierarchy so that only products have a sale price are displayed. The projects hierarchy includes a plurality of projects organized into categories and sub-categories similarly to the products hierarchy. The product descriptions include links to related products that are required or useful for that particular project.

A store map screen is linked to one of the start screen buttons. The store map includes a plurality of department buttons integrated into a store layout. A store services screen is also linked to one of the start screen buttons. The store services screen provides access to one or more service description screens that give a user information about services provided by the store.

The operator interface of the present invention provides the user with a small number of concise choices and intuitive steps that lead the user to the desired information. Thus the invention provides a simple interface that a user can use without prior knowledge of how to use the system and that lets the user get to the desired information quickly, without having to sift through extraneous information. Further, the invention provides the user with adequate information to make a purchase decision as well as other useful information such as product location, special prices, products related to a chosen product, and shopping lists.

### BRIEF DESCRIPTION OF THE DRAWINGS

The above-mentioned and other features and advantages of this invention, and the manner of attaining them, will become apparent and be better understood by reference to the following description of an embodiment of the invention in conjunction with the accompanying drawings, wherein:

FIG. 1 is a flow chart of a operator interface system according to the present invention;

FIGS. 2a, 2b, and 2b are examples of the start screens and sleep screen of the operator interface system;

FIG. 3 is an example of a products screen of the operator interface;

FIGS. 4a-4i are examples of screens in the product hierarchy of the operator interface;

FIGS. 5a and 5b are examples of shopping list screens of the operator interface;

FIGS. 6a and 6b are examples of screens in the filtered product hierarchy of the operator interface;

FIGS. 7a-7g are examples of screens in the project hierarchy of the operator interface;

FIG. 8a is an example of a search screen of the operator interface;

FIG. 8b is an example of a search results screen of the operator interface;

FIG. 9 is an example of a store map screen of the operator interface;

FIG. 10 is an example of a screen in the store services section of the operator interface;

FIG. 11a is an isometric view of a kiosk of the present invention; and

FIG. 11b is a plan view of a hand-held touch screen device of the present invention.

Corresponding reference characters indicate corresponding parts throughout the several views. The example set out herein illustrates one embodiment of the invention but should not be construed as limiting the scope of the invention in any manner.

### DETAILED DESCRIPTION

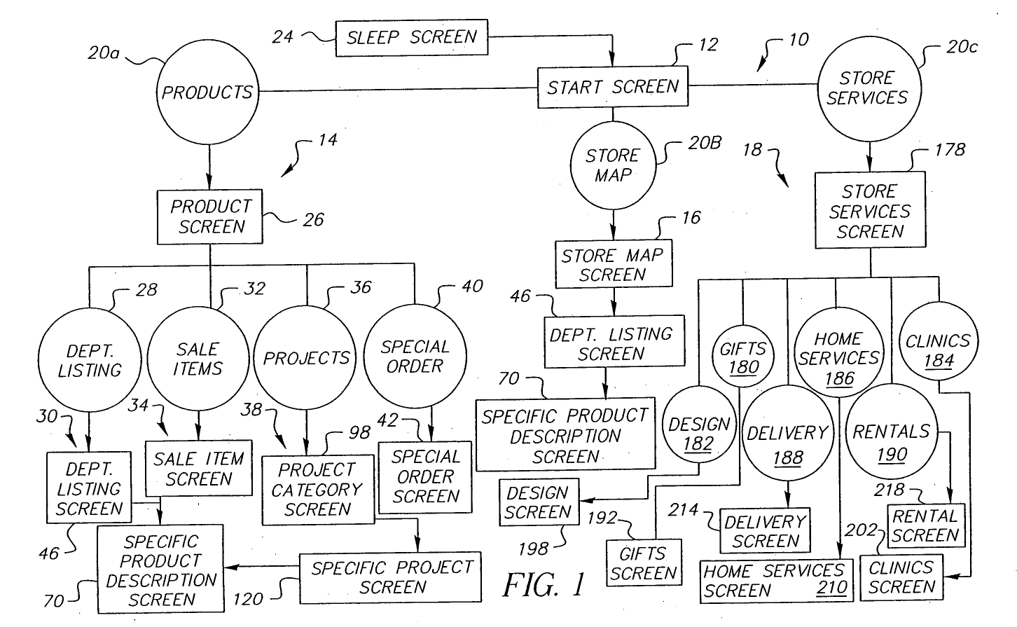

Referring to FIG. 1, there is shown the touch screen operator interface system of the present invention. The operator interface system 10 is an operating system that may be written in any suitable computer language, for example Sun Microsystems' Java, C++, or Microsoft's Visual Basic. The operator interface system 10 includes a start screen 12, a products section 14, a store map 16, and a store services section 18.

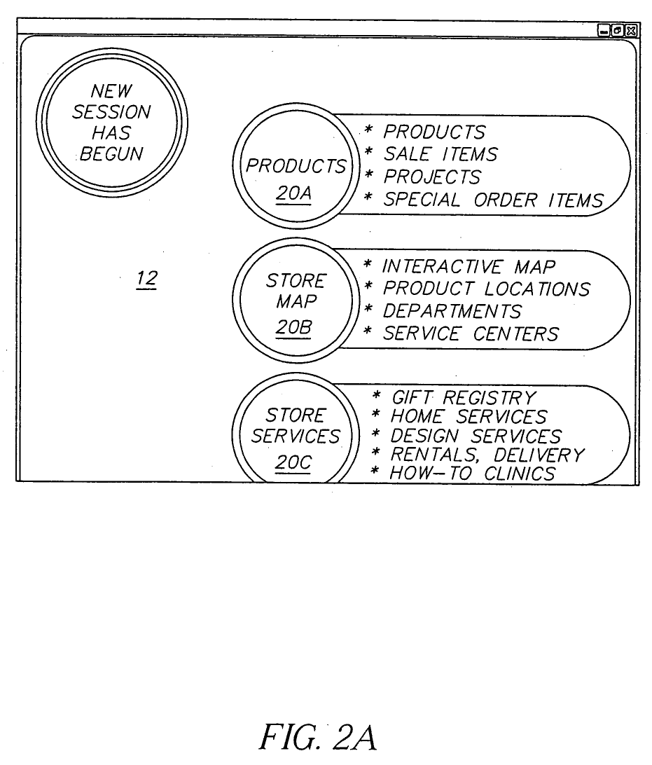

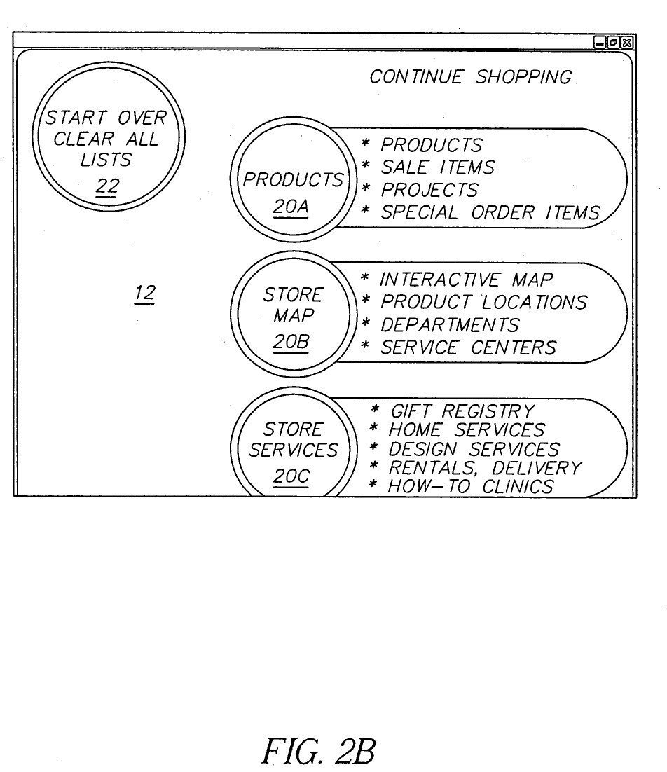

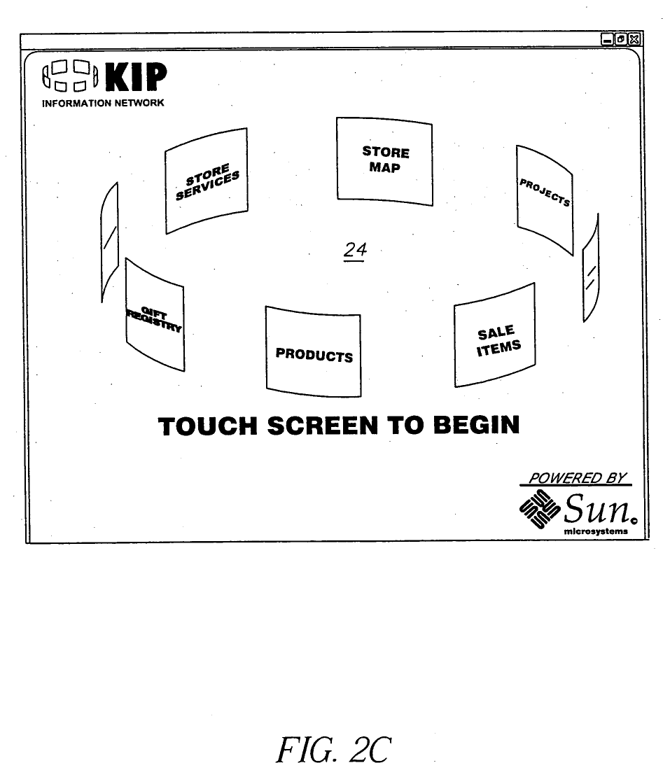

The start screen 12 is normally displayed on a touch screen display and includes three start screen buttons 20a, 20b, and 20c. The start screen buttons 20a, 20b, and 20c are much larger than the tip of an index finger—at least twice as large as an index finger as shown in FIG. 2a—to allow for easy actuation of the buttons. The first start screen button 20a links to the products section 14, the second start screen button 20b links to the store map 16, and the third start screen button 20c links to the store services section 18. Each of the start screen buttons includes a brief description of the content that may be reached by actuating that button. An example of the start screen 12 is shown in FIG. 2a. The start screen 12 may also include a reset button 22 shown in FIG. 2b. The reset button 22 clears any lists and resets any variables a user may have modified during use of the operator interface system 10. There is also a sleep screen 24 that is displayed when the operator interface has not been used in a set period of time. An example of a sleep screen 24 is shown in FIG. 2c. The whole sleep screen 24 may be set as a target so that a user may touch the screen anywhere to bring up the start screen shown in FIG. 2a.

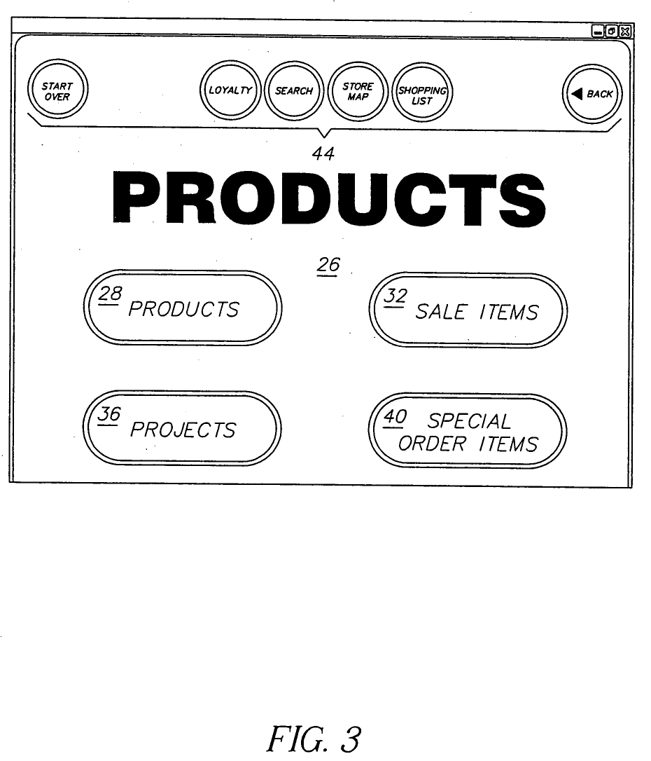

When a user actuates the first start screen button 20a, a products screen 26 is displayed on the touch screen display. The products screen 26 is the top level of the products section 14 and is shown in FIG. 3. The products screen 26 includes a department listing button 28 that links to a product hierarchy 30, a sale items button 32 that links to a filtered product hierarchy 34, a projects button 36 that links to a projects hierarchy 38, and a special order items button 40 that links to an order form 42. The order form 42 allows the user to order specific products that the store doesn't normally keep in stock.

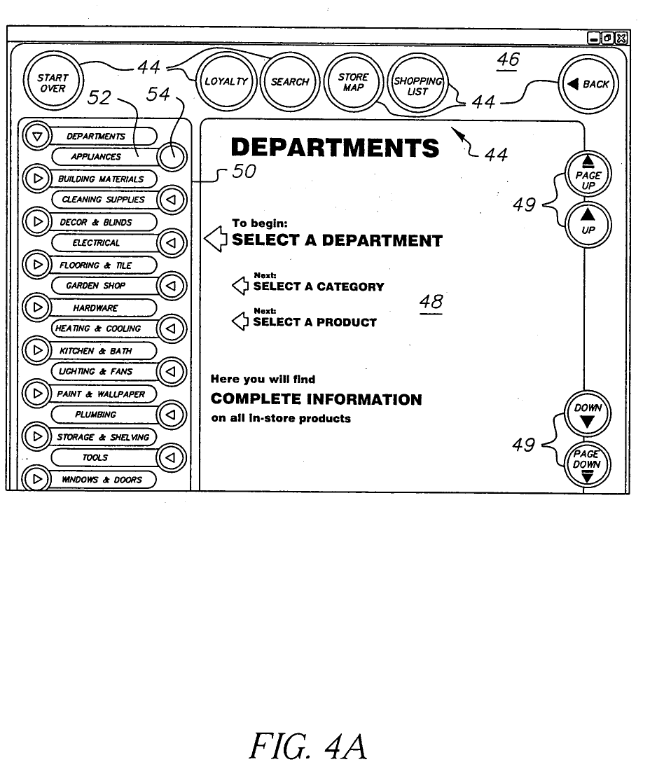

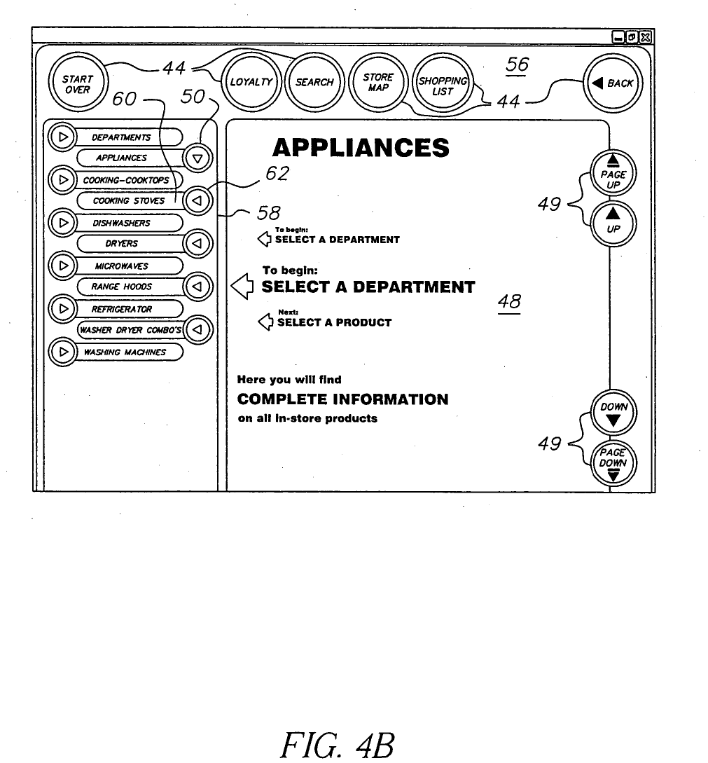

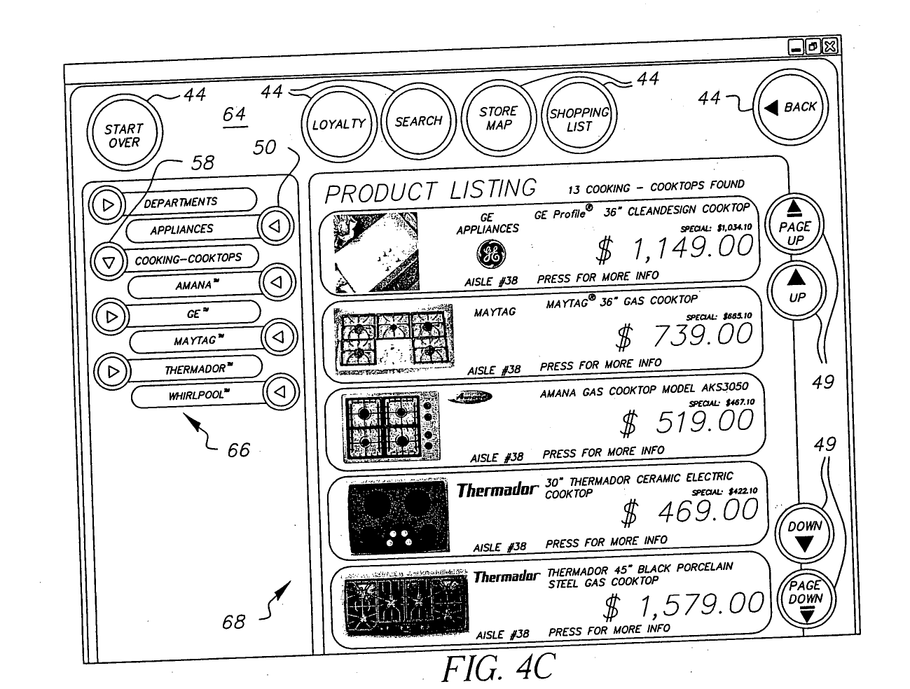

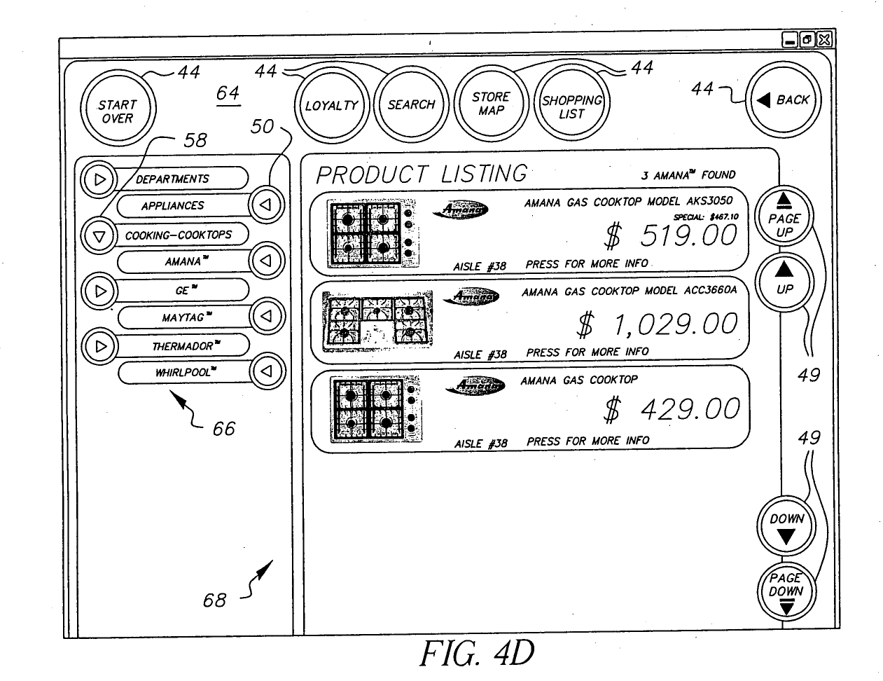

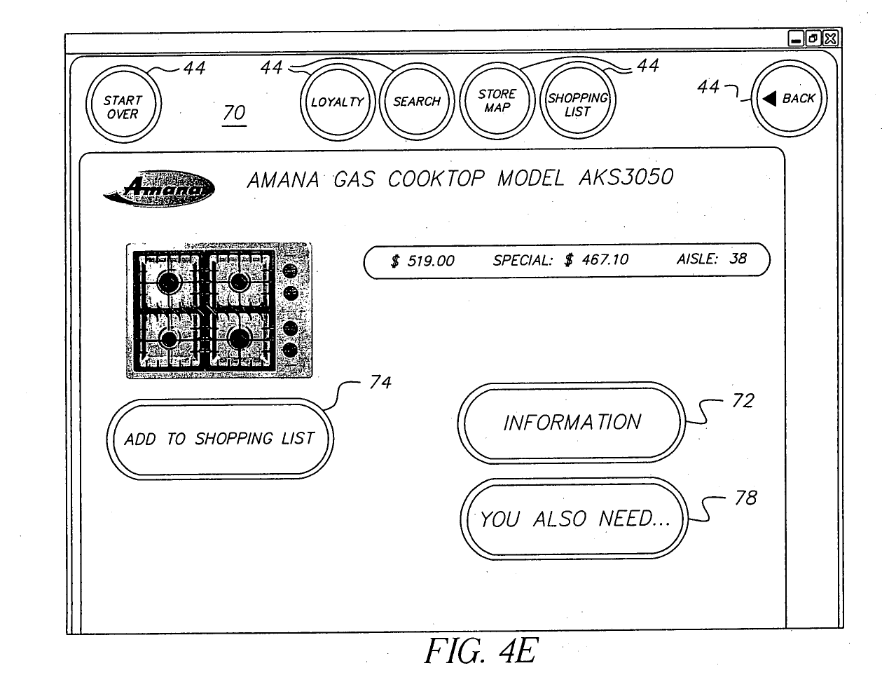

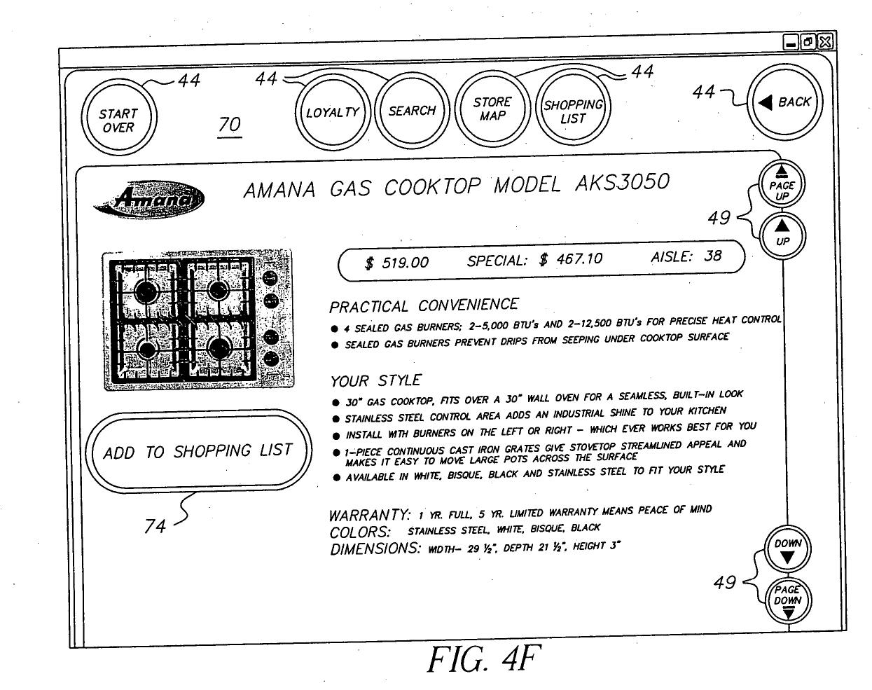

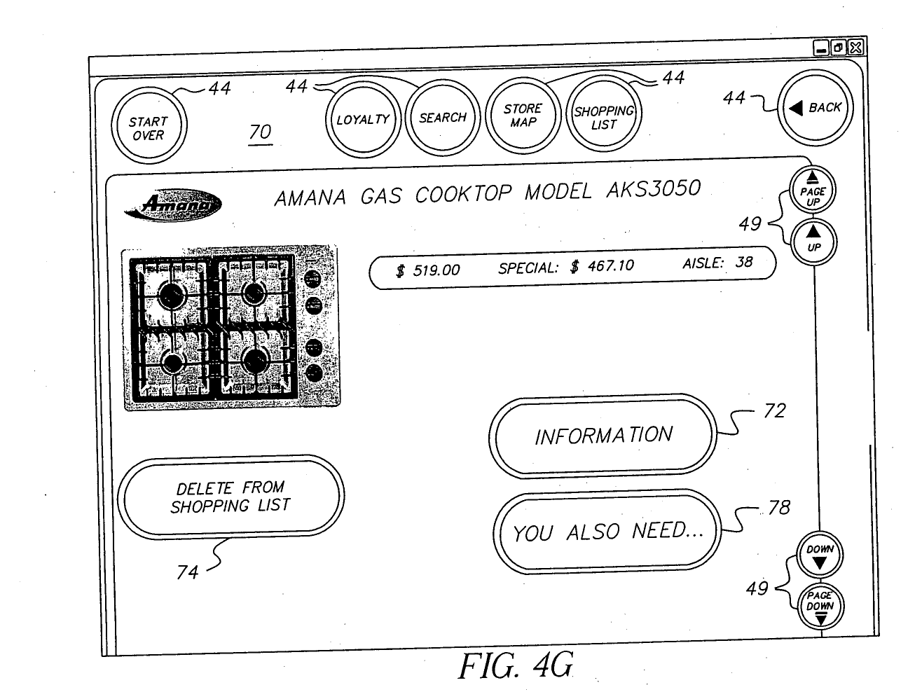

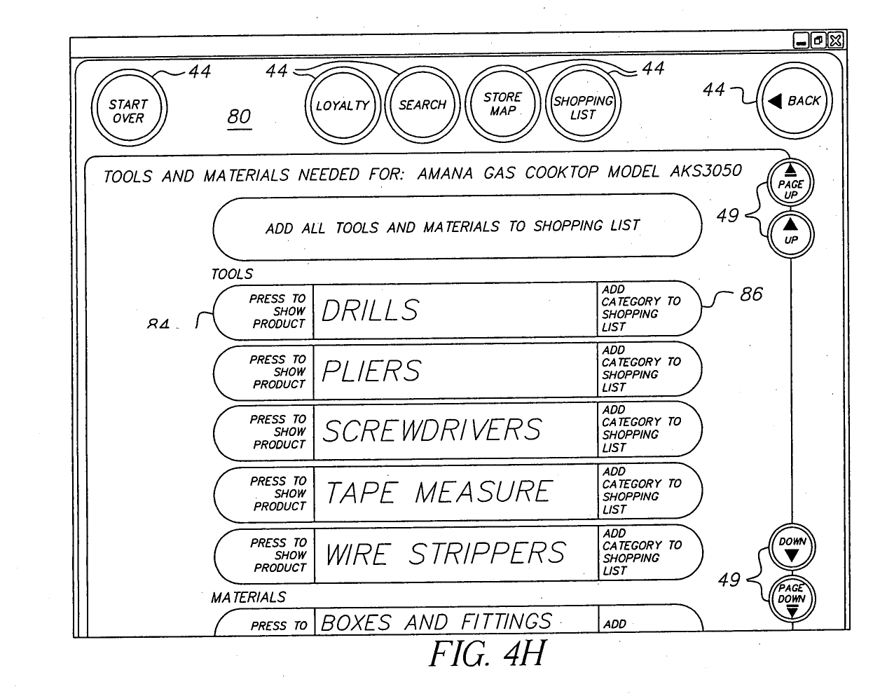

The top level of the product hierarchy 34 is the department listing screen 46 shown in FIG. 4a. The department listing screen 46 includes a product hierarchy guide 48 that informs a user where s/he is in the hierarchy and the steps required to get to a product description. Scroll buttons 49, shown in FIG. 4a, allow a user to scroll the page up or down as needed. When the page fits on the display, the scroll buttons 49 are grayed so the user knows that they are not active. The scroll buttons 49 as well as a plurality of navigation buttons 44 are included on most of the screens in the product hierarchy 34 and in other areas of the operator interface 10 as will be seen in the subsequent figures. The department listing screen 46 also includes a plurality of store department buttons 50. Each of the store department buttons 50 has a department title 52 and an enlarged target 54. The enlarged targets 54 alternate sides of the department title 52 to allow a large number of store department buttons 50 to be listed on the department listing screen 46 while giving a user a large target to hit when actuating one of the store department buttons 50. Each of the store department buttons 50 links to a category listing screen 56 shown in FIG. 4b. The category listing screen 56 includes the product hierarchy guide 48 and a plurality of category buttons 58. Each of the category buttons 58 includes a category title 60 and an enlarged target 62 similar to the department titles 52 and the enlarged targets 54. FIG. 4b shows that the actuated store department button 50 remains visible at the top of the list on the category listing screen 56.

Each of the category buttons 58 links to a product listing screen 64, shown in FIG. 4c, that includes a plurality of manufacturer buttons 66 and a plurality of product buttons 68. The actuated store department button 50 and category button 58 remain visible at the top of the list on the product listing screen 64. The manufacturer buttons 66 filter the product buttons 68 by manufacturer as shown in FIG. 4d. Each of the product buttons 68 includes a brief description and a picture of a product that fits under the chosen category. The product buttons 68 may also include the location of the product within the store.

The product buttons 68 each link to a specific product description screen 70 shown in FIG. 4e. The specific product description screen 70 includes information about the product such as the cost, special prices, if any, the location within the store, and a picture. An information button 72 causes a detailed product description from the manufacturer to be displayed as shown in FIG. 4f. The product description screen 70 as shown in FIG. 4e further includes a shopping list toggle button 74, which alternately adds the current product to a shopping list 76 or removes the current product from the shopping list 76. The product description screen 70 shown in FIG. 4g shows a product that is on the shopping list 76, thus the shopping list toggle button 74 will remove the item from the shopping list 76 when actuated. The specific product description screen 70 further includes a related products button 78 that links to a related products screen 80 shown in FIGS. 4h, and 4i. The related products screen 80 includes a category list 82 organized by department. The user may see more of the category list 82 by scrolling down using the scroll buttons 49. Each item in the category list 82 includes a show product button 84 and a shopping list toggle button 86. The show product buttons 84 cause the category list 82 to display the product buttons 68 for products under a particular category as shown in FIGS. 4h and 4i. Items may be added to the shopping list 76 individually by actuating a shopping list toggle button 74 located on the product button 68 or a category may be added to the shopping list 76 by actuating the shopping list toggle button 86. Further, a button is provided to allow one to add all the related categories to the shopping list 76.

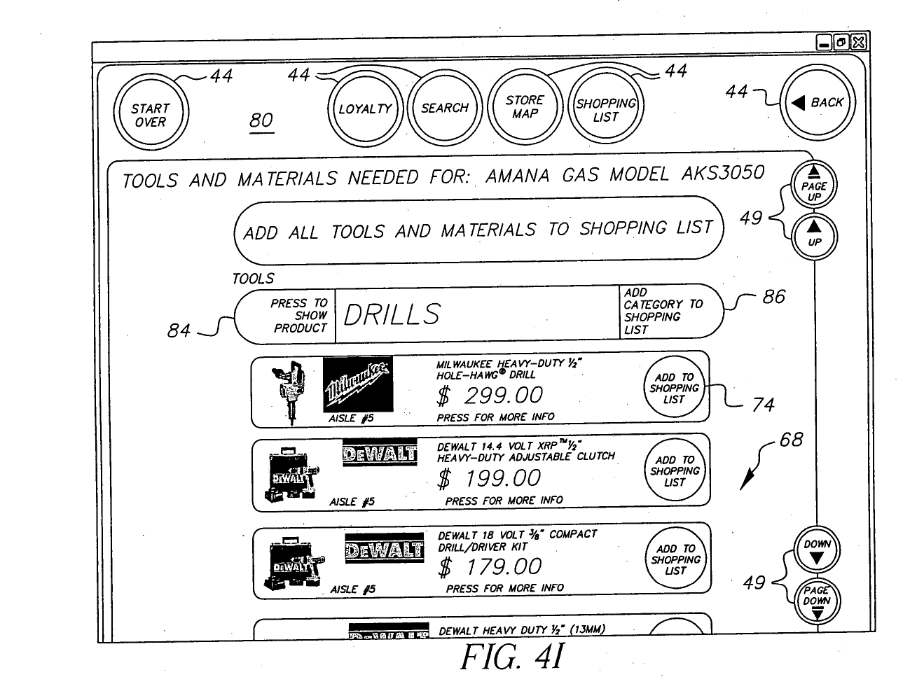

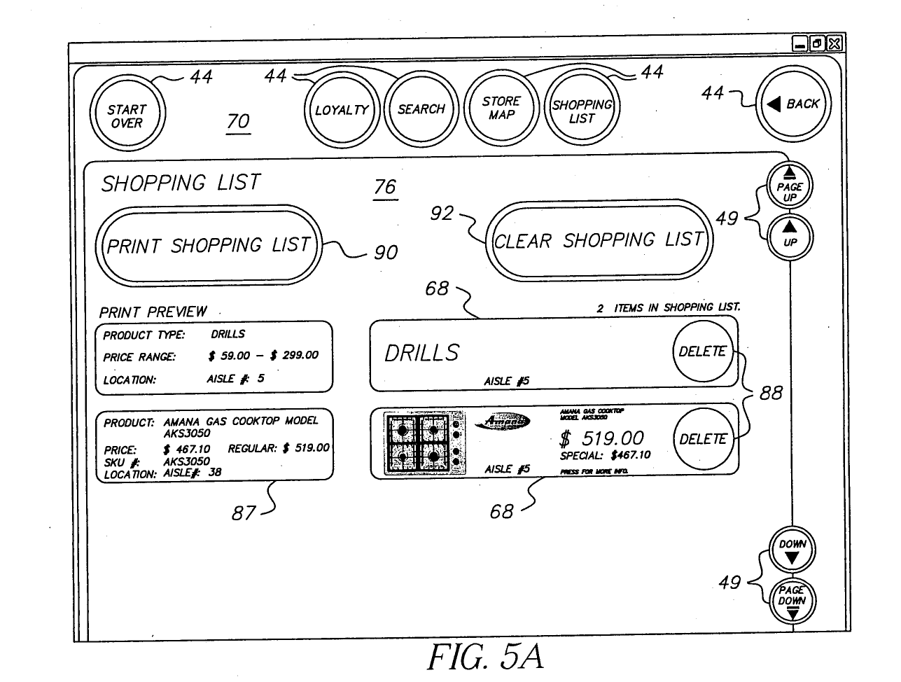

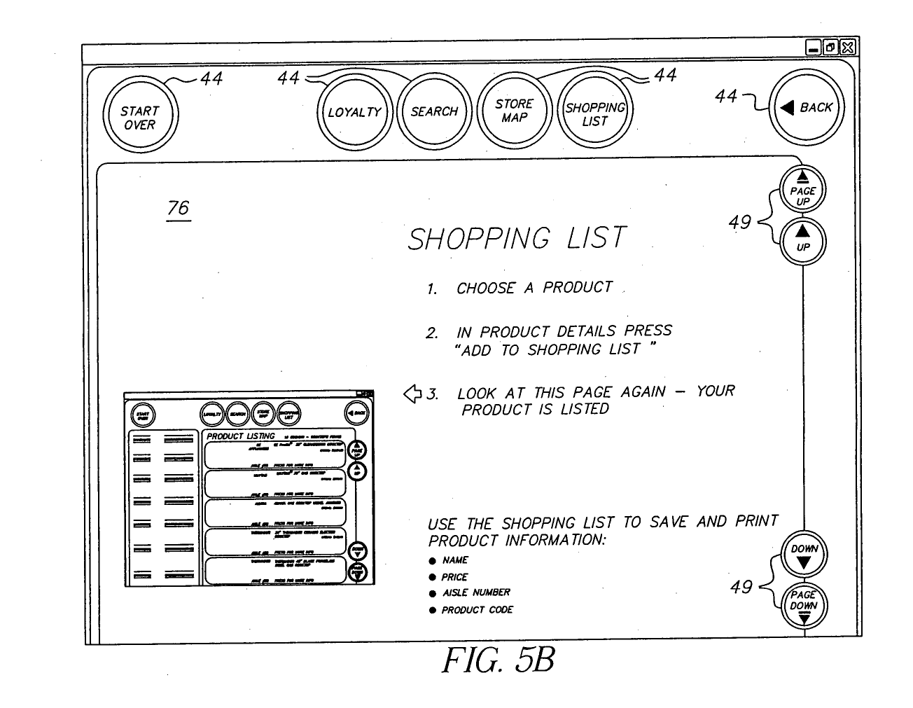

An example of the shopping list 76 is shown in FIG. 5a. The shopping list 76 includes a one or more product buttons 68 as well as a print preview 87 for each item. Further, if a category has been added to the shopping list 76, that category is listed with it's location within the store. The product buttons 68 and categories in the shopping list 76 may be removed from the shopping list 76 individually by the delete buttons 88 associated with each. The entire shopping list 76 may be printed using a print button 90 or cleared using a shopping list reset button 92. An empty shopping list 76 that gives the user instructions on how to add items to the shopping list 76 is shown in FIG. 5b.

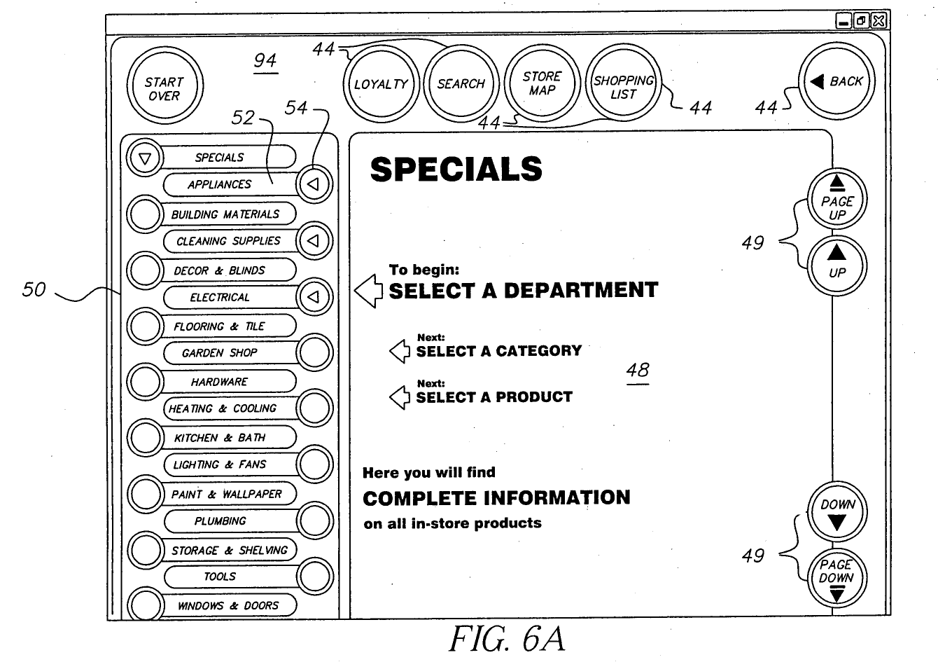

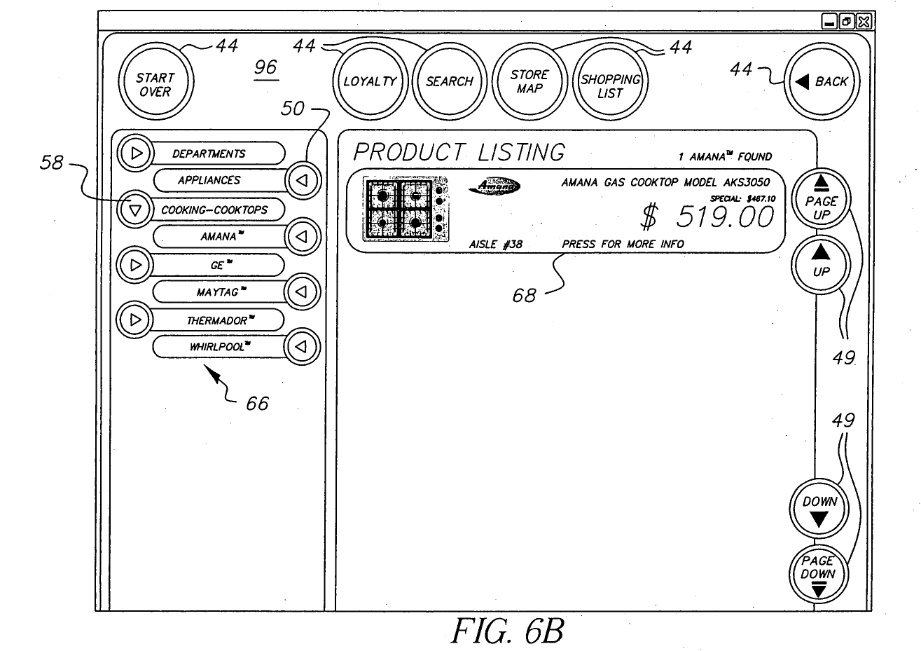

The specials screen 94, shown in FIG. 6a, is displayed when the sale items button 32 on the products screen (FIG. 3) is actuated. The specials screen 94 is similar to the department listing screen 46, shown in FIG. 4a, except that the store department buttons 50 are only active if they contain items with a special price. Non-active store department buttons 50 are grayed to let the user know that the button is not active. Special product listing screen 96 is shown in FIG. 6b and is similar to the product listing screen 96 shown in FIG. 4d except that only product buttons 68 that are associated with products having a special price are listed. The specific product description screen 70 (FIG. 4e) is displayed when the product button 68 on the special product listing screen 96 is actuated. The specific product description screen 70 has the same features described above.

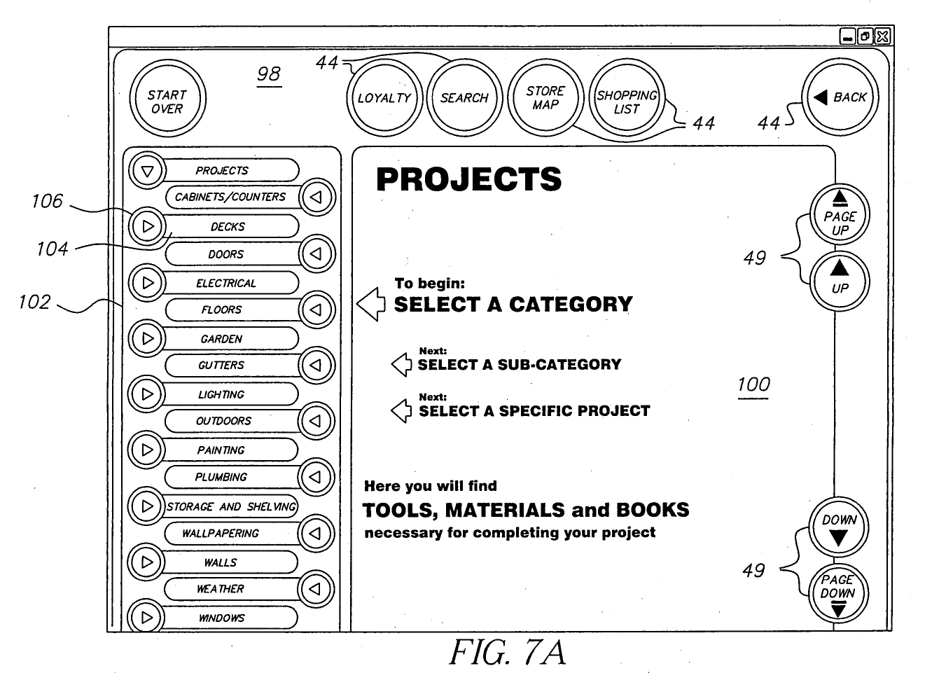

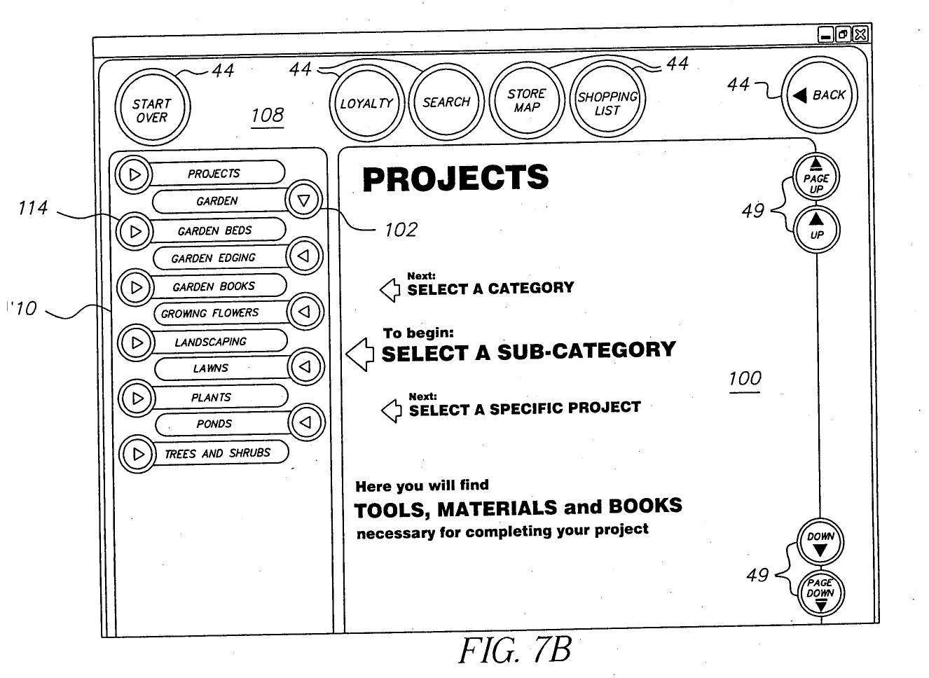

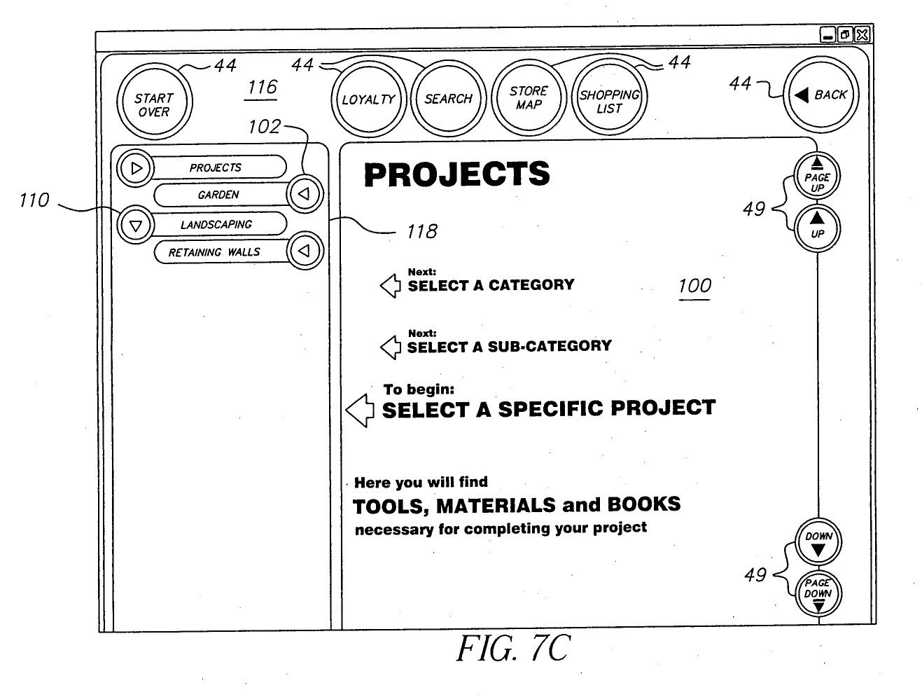

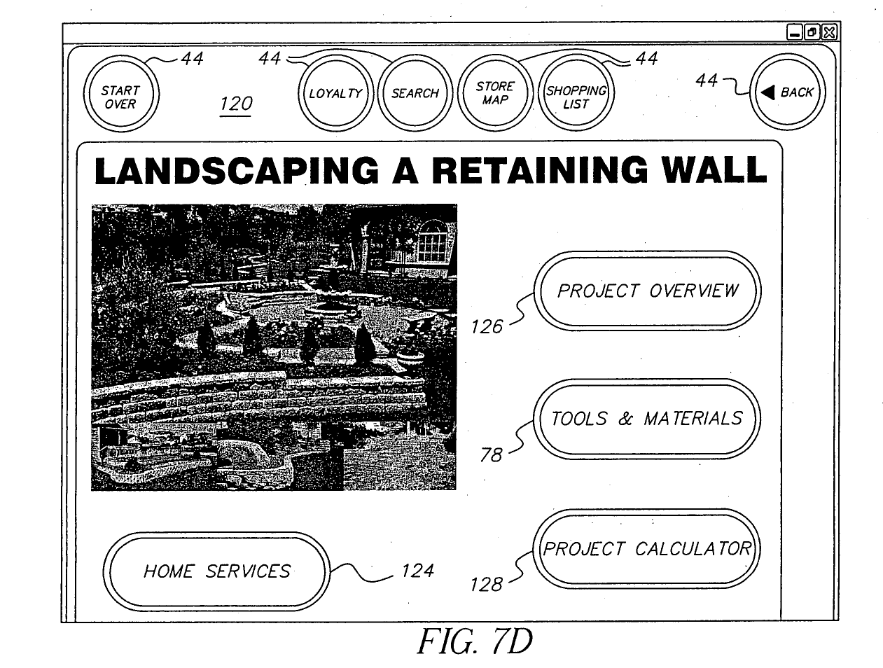

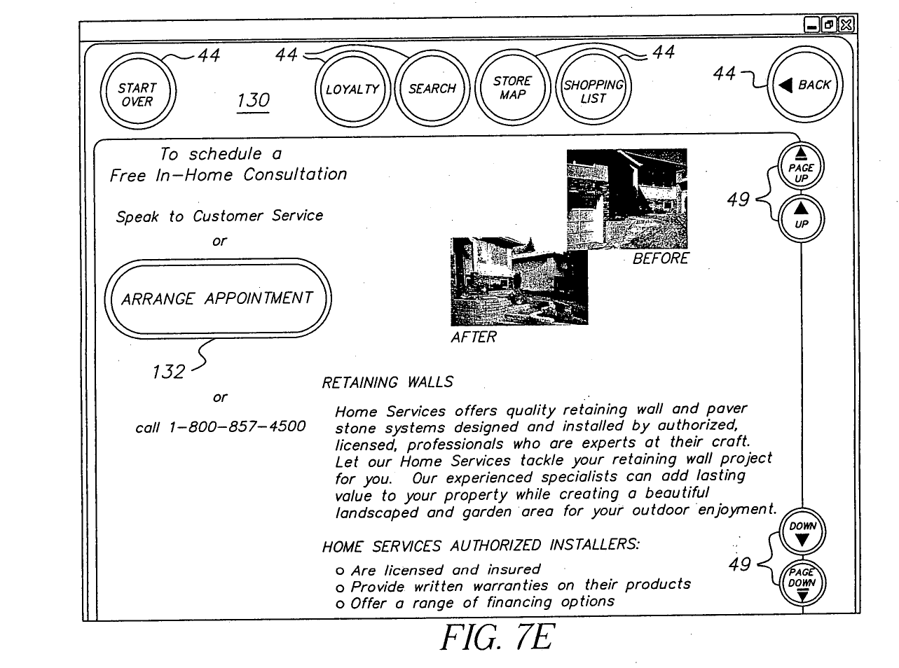

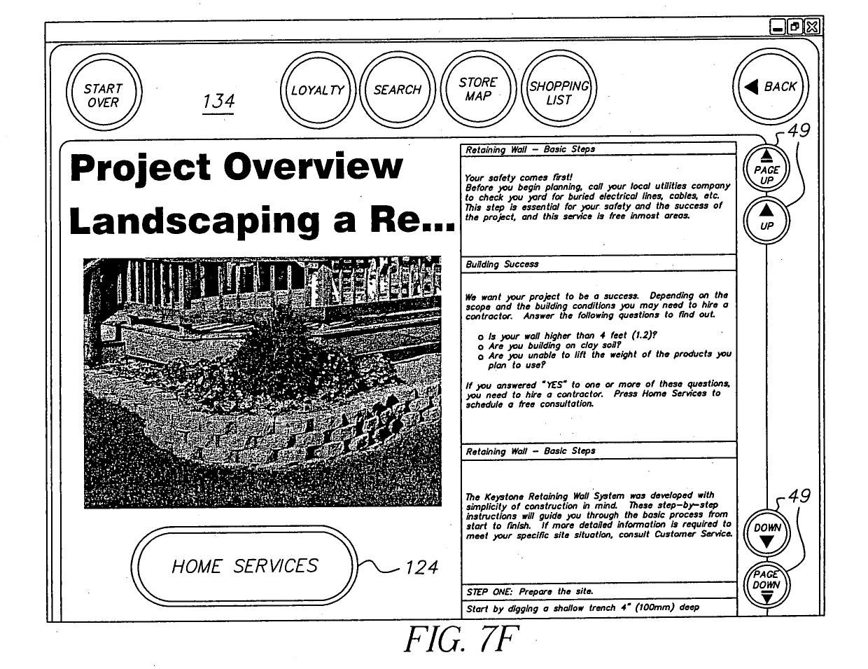

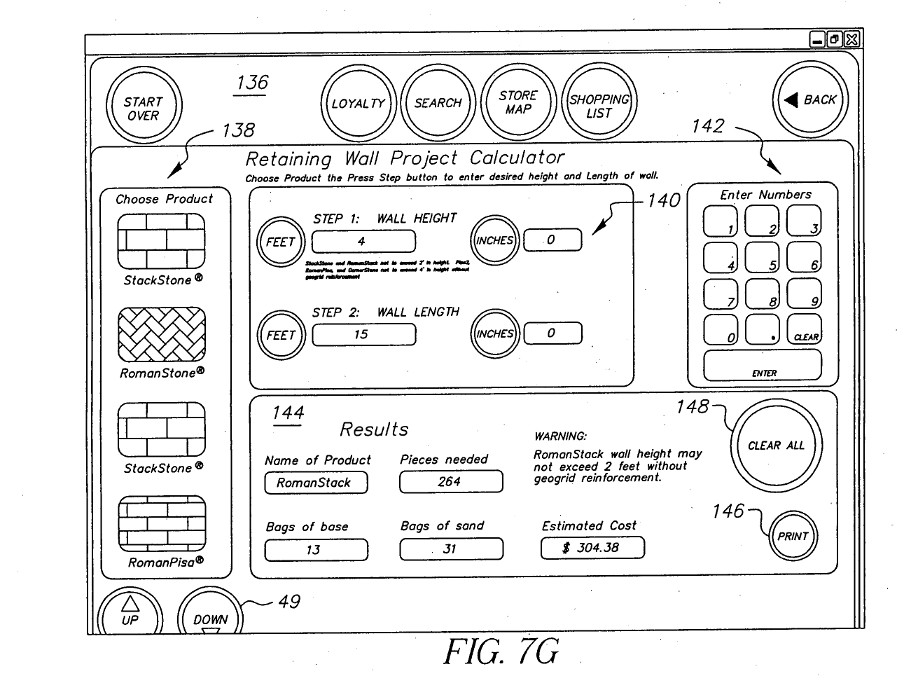

The top level of the projects hierarchy 38 is a project category listing screen 98, which is reached by actuating the projects button 36 on the products screen 26 (FIG. 3). The project category listing screen 98 is shown in FIG. 7a and includes a project hierarchy guide 100 that is similar in configuration to the product hierarchy guide 48. The project category listing screen 98 also includes several project category buttons 102 with project category titles 104 and enlarged targets 106. Each of the project category buttons 102 links to a project sub-category listing screen 108, shown in FIG. 7b. The project sub-category listing screen 108 includes the project hierarchy guide 100 and a plurality of project sub-category buttons 110. Each of the project sub-category buttons 110 includes a project sub-category title 112 and an enlarged target 114. FIG. 7b shows that the actuated project category button 102 remains visible at the top of the list on the project sub-category listing screen 108.

Each of the project sub-category buttons 110 links to a project listing screen 116, shown in FIG. 7c, that includes one or more specific project buttons 118. The actuated project category button 102 and project sub-category button 110 remain visible at the top of the list on the project listing screen 116. Each of the specific project buttons 118 links to a specific project screen 120. An example of a specific project screen 120 is shown in FIG. 7d. The specific project screen 120 may include a large image 122 that represents the project either finished or in process to let the user quickly ascertain what the project is. The specific project screen 120 also includes a service button 124, a project overview button 126, a related products button 78, and a project calculator 128. The service button 124 links to a service screen 130, such as the one shown in FIG. 7e. The service screen 130 lets the user know how to obtain more information and may include an information request button 132 that links to a screen or a series of screens that obtain the user's contact information so that a customer service representative for the store may contact the user at a later date. The service button 124 may alternatively link to a screen in the store services section 18.

The project overview button 126 links to project detail screen 134 that provides the user with details about the project, such as step-by-step instructions and figures. The project detail screen 134 may include the service button 124 and a print button (not shown). The related products button 78 links to the related products screen 80 described above. The project calculator button 128 links to a project calculator screen 136 such as the one shown in FIG. 7g. This example of the project calculator screen 136 helps the user determine the amount of key project materials required and provides a cost estimate for those materials. The project calculator screen 136 includes a project materials list 138, several parameter entry fields 140, an on-screen key pad 142, and a results area 144. The user selects a product from the project materials list 138 and for each of the parameter entry fields 140, the user actuates the button next to the field and enters the parameter associated with that field using the key pad 142. The results of the calculation are shown in the results area 144, which may also include a warning if any of the parameters are outside limits set by the manufacturer or the store policy. The parameters may be changed using the parameter entry fields 140. The results may be printed using the print button 146 or cleared using the calculator reset button 148.

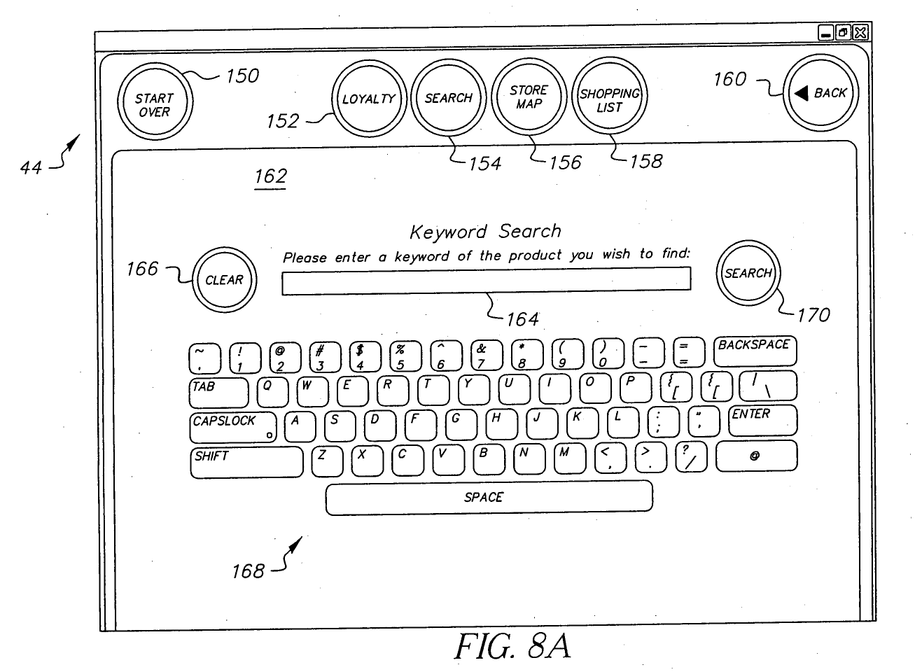

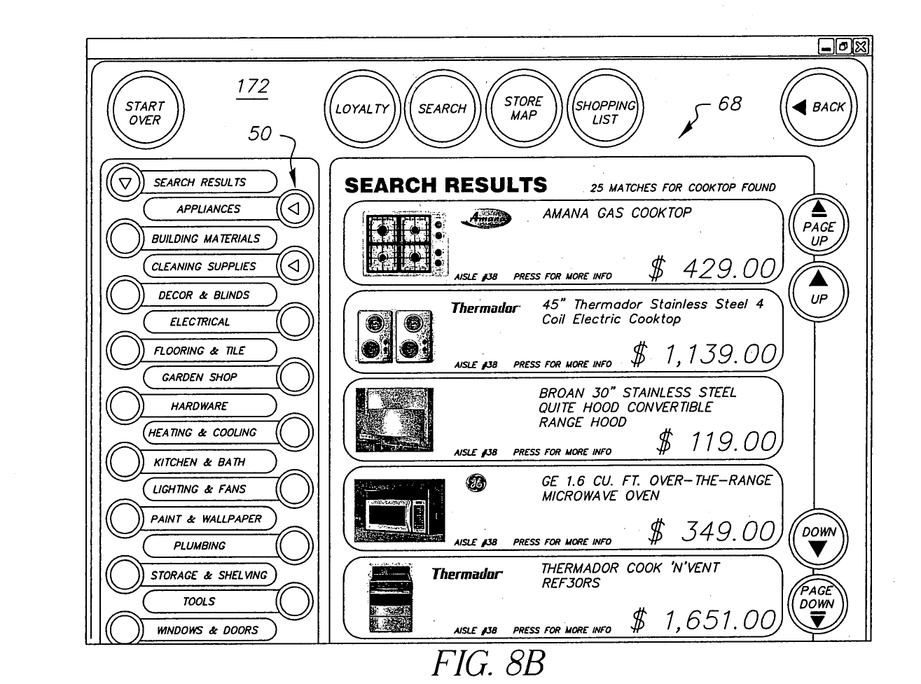

Most screens in the products section 14 have several navigation buttons 44 shown in FIG. 8a. The navigation buttons 44 include an exit button 150, a loyalty button 152, a search button 154, a store map button 156, a shopping list button 158, and a back button 160. The exit button 150 links to the start screen 12 shown in FIG. 2b. The loyalty button 152 links to a loyalty screen that informs users about specials that may or may not be indicated elsewhere in the operator interface system 10. The loyalty screen may also allow the user to print coupons. The loyalty screen may require the user to register and log into a loyalty account or otherwise prove that the user is a repeat customer.

The search button 154 links to a search screen 162 shown in FIG. 8a. The search screen allows the user to search the operator interface system 10 for keywords and includes a keyword entry field 164, a search reset button 166, an on-screen keyboard 168, and a search button 170. After entering a keyword using the keyboard 168, the user either clears the search using the search reset button 166 or activates the search using the search button 170. The search results are displayed on a search results screen 172, shown in FIG. 8b. The search results screen 172 includes a list of product buttons 68 for products that are related to the keyword used in the search. The search results screen 172 also includes a list of store department buttons 50 of the product hierarchy 30. Only store department buttons 50 that include products related to the keyword are active and inactive store department buttons 50 are grayed. The user may use the active store department buttons 50 and the subsequent category buttons 58 and manufacturer buttons 66 to filter the list of search results.

The store map button 156 links to the store map 16 and the shopping list button 158 links to the shopping list 76. The back button 160 links to the screen previous to the current screen. The navigation buttons 44 are grayed when they are not active.

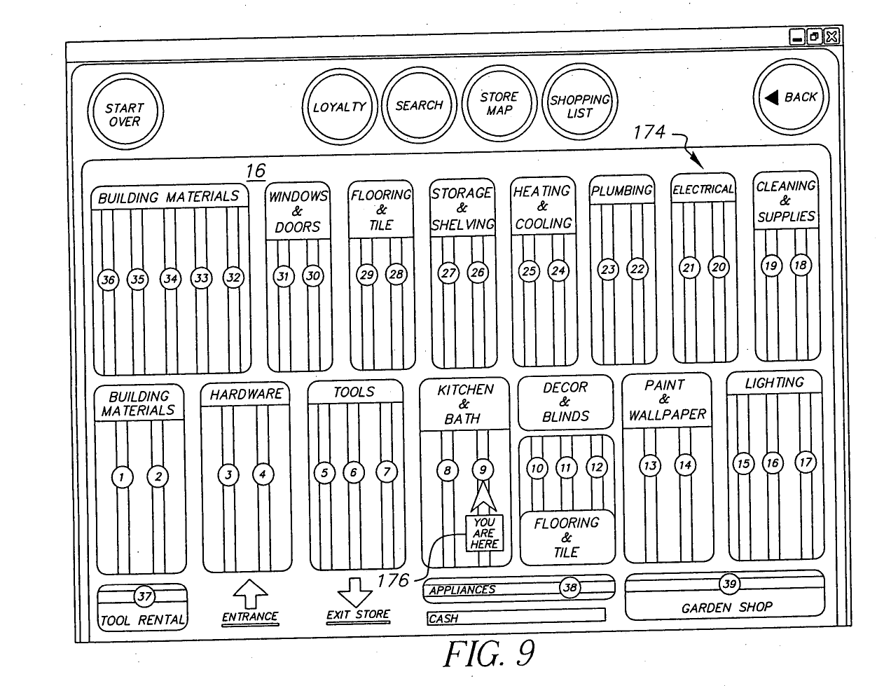

When a user actuates the second start button 20b or the store map button 156, the store map 16 is displayed. The store map 16, shown in FIG. 9, includes a plurality of map buttons 174 that are labeled according to store departments and are laid out on the display according to the store's actual physical layout. The map buttons 174 are also labeled with the aisle numbers of the aisles encompassed by the department. Each of the map buttons 174 links to the category listing screen 56 of the product hierarchy 30 associated with the department indicated on the actuated map button 174. The store map 16 may also include a kiosk location marker 176 as well as the location of the entrance and exit to help the user get his or her bearings.

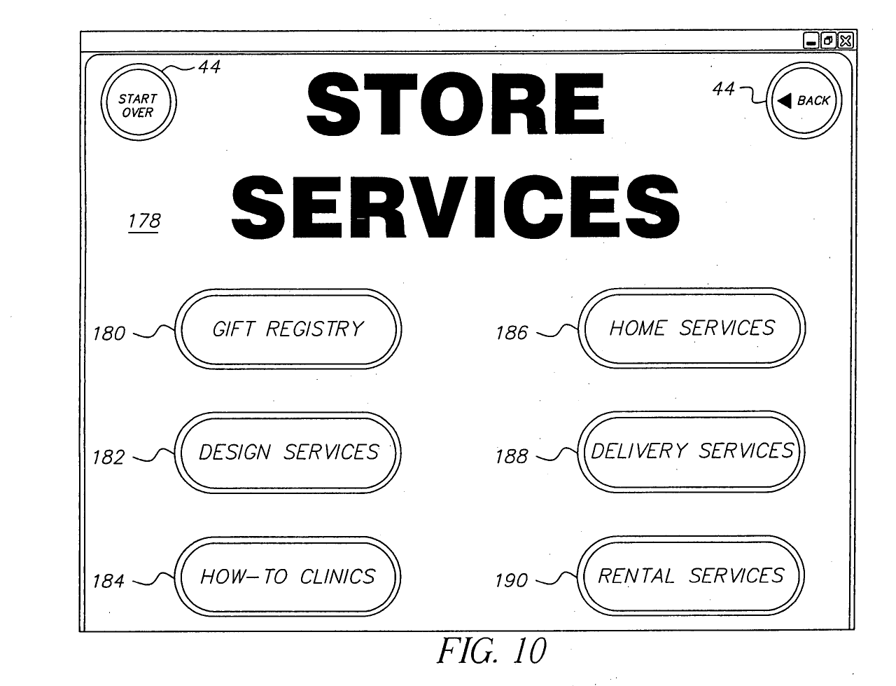

The third start button 20c links to a store services screen 178 in the store services section 18. The store services screen 178, shown in FIG. 10, includes navigation buttons 44, a gifts button 180, a design services button 182, a clinics button 184, a home services button 186, a delivery services button 188, and a rental services button 190. The gifts button 180 links to a gifts screen that allows a user to set up and maintain a gift registry or to access another user's gift registry. More particularly, the user may perform a search for a particular gift registry and print out the associated shopping list with product locations. The design services button 182 of FIG. 10 links to a design services screen, which provides general information about design services provided by the store and links to a store map that indicates the physical location of the design center in the store. Further, the design services screen may include functionality that allows the user to sign up for a consultation with a design professional using the operator interface system 10. The clinics button 184 of FIG. 10 links to a clinics screen, which includes information about clinics that the store may host or sponsor and a schedule of such clinics. The clinics screen also includes functionality collects the user's contact information such that the operator interface system 10 may automatically e-mail the current clinic schedule to the e-mail address. Alternatively, the contact information may be added to a distribution list that periodically e-mails an updated clinic schedule. Further, the clinic schedule may be periodically mailed to the user via the U.S. Postal Service.

The home services button 186 of FIG. 10 links to a home services screen, which includes information about the home services provided by the store and allows the user to schedule an appointment with a home services representative associated with the store. The delivery services button 188 of FIG. 10 links to a delivery services screen that includes information about the delivery services provided by the store and links to a store map that indicates the physical location of the delivery services in the store. The rental services button 190 of FIG. 10 links to a rental services screen that includes information about the rental services provided by the store and links to a store map that indicates the physical location of the rental services in the store.

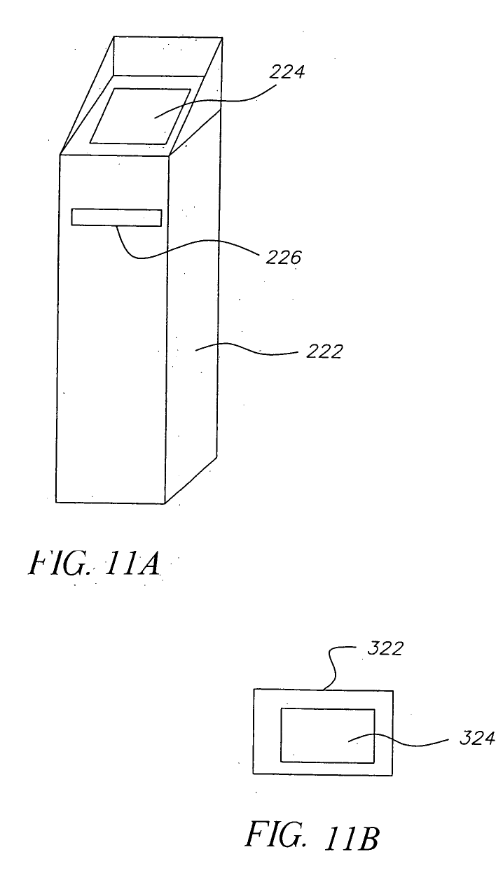

In the present embodiment, the operator interface system 10 operates on an in-store kiosk 222 shown in FIG. 11a. Any number of kiosks 222 may be included in a store. The kiosk 222 includes a terminal computer, a touch screen display 224, and a printer that outputs paper through a slot 226. The terminal computer is networked to a central computer that contains the product information database. The central computer may be a local server within the store or a remote server that supports several store locations having one or more kiosks 222. The central computer may also be connected to a larger network. Alternatively, the kiosk 222 is a self contained computer having the product information database stored locally so that the kiosk 222 does not need to be networked.

In another embodiment, the operator interface 10 runs on a mobile touch screen device 322 similar to a personal digital assistant (PDA). The device 322 is shown in FIG. 11b and may be hand-held or attached to a shopping cart. The device 322 includes a touch screen display 324 and may be wirelessly networked to a central computer that contains the product information database. Alternatively, the device 322 is a self contained computer having the product information database stored locally. In either case, the device 322 may include tracking functionality such that the device 322 monitors where the user is within the store. Thus the store map 16 may display the location of the user so the user knows where he or she is relative to the products that he or she is looking for. Further, the device 322 may respond to devices such as radio frequency (RF) tags that indicate that the user is moving past a sale item or a particular product that the user has placed on his or her shopping list.

The operator interface of the present invention provides a customer with an intuitive interface for finding desired products and useful information about those products. The layout and hierarchical structure of the operator interface 10 as well as the consistency between screens in the operator interface system 10 makes the system simple to use. The user isn't faced with a large number of choices at any given time. The operator interface system 10 also provides the user with adequate information for making a purchasing decision. Information about the product such as it's location within the store, related products, special prices, projects that use the products, etc. is also provided. The shopping list 76, which is easy to build and print, aids the user in picking up chosen items.

It should be particularly noted that the store services described above are examples and other store services content may be included in the operator interface system 10.

It should be further noted that the operator interface system 10 may include functionality to allow a user to register and save parameters for later retrieval. For example, a user may wish to save a shopping list to be printed on a future visit to the store.

It should be even further noted that the shopping list may be organized by product location to allow the user to find products efficiently while following the list.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. An operator interface system for a touch screen device, comprising:
a start screen having no more than five start screen buttons, wherein the start screen buttons are chosen from a group of buttons consisting of a start screen map button, a start screen products button, a start screen store services button, and a start screen reset button;
a store map screen linked to one of the start screen buttons, wherein said store map comprises a store layout and map department buttons integrated into the store layout;
a products screen linked to one of the start screen buttons, said products screen having a department listing button and a sale item listing button; and
a store services screen linked to one of the start screen buttons, said store services screen having one or more service description screen buttons.

2. The operator interface of claim 1, wherein each of the start screen buttons are at least twice the size of the tip of an index finger.

3. The operator interface of claim 1, wherein said store map further comprises an exit button that links to a previously displayed screen.

4. The operator interface of claim 1, wherein said store map further comprises an exit button that links to said start screen.

5. The operator interface of claim 1, further comprising a department listing screen linked to the department listing button of said products screen.

6. The operator interface of claim 5, wherein said department listing screen comprises a plurality of store department buttons.

7. The operator interface of claim 6, wherein said department listing screen further comprises a message area and a plurality of navigation buttons.

8. The operator interface of claim 7, wherein the plurality of navigation buttons include a start over button that links to said start screen, a back button that links to a previously displayed screen, a store map button that links to said store map, a scroll up button, and a scroll down button.

9. The operator interface of claim 6, further comprising a category listing screen for each of said store department buttons, wherein said category listing screen comprises a plurality of category buttons and a plurality of navigation buttons.

10. The operator interface of claim 9, further comprising a product listing screen for each of the category buttons, wherein said product listing screen comprises a plurality of manufacturer buttons and a product button list having a plurality of specific product buttons.

11. The operator interface of claim 10, further comprising a product detail screen for each of the specific product buttons, said product detail screen comprising a description of a product, a plurality of navigation buttons, and a shopping list button.

12. The operator interface of claim 11, wherein the shopping list button causes the current product to be added to a shopping list when actuated.

13. A retail sales apparatus comprising a kiosk at a point-of-sale site wherein said kiosk has a display and an operator interface system, comprising:
a start screen having no more than five start screen buttons, wherein the start screen buttons are chosen from a group of buttons consisting of a start screen map button, a start screen products button, a start screen store services button, and a start screen reset button;
a store map screen linked to one of the start screen buttons, wherein said store map screen comprises a store layout and map department buttons integrated into the store layout;
a products screen linked to one of the start screen buttons, said products screen having a department listing button and a sale item listing button; and
a store services screen linked to one of the start screen buttons, said store services screen having one or more service description screen-buttons.

14. The retail sales apparatus of claim 13, wherein said store map further comprises an exit button that links to a previously displayed screen.

15. The retail sales apparatus of claim 13, wherein said operator interface system further comprises a department listing screen linked to the department listing button of said products screen.

16. The retail sales apparatus of claim 15, wherein said department listing screen comprises a plurality of store department buttons and a plurality of navigation buttons.

17. The retail sales apparatus of claim 16, wherein said operator interface system further comprises a category listing screen for each of said store department buttons, wherein said category listing screen comprises a plurality of category buttons and a plurality of navigation buttons.

18. The retail sales apparatus of claim 17, wherein said operator interface system further comprises a product listing screen for each of the category buttons, wherein said product listing screen comprises a plurality of manufacturer buttons and a product button list having a plurality of specific product buttons.

19. The retail sales apparatus of claim 18, wherein said operator interface system further comprises a product detail screen for each of the specific product buttons, said product detail screen comprising a description of a product, a plurality of navigation buttons, and a shopping list button.

20. The retail sales apparatus of claim 13, wherein said kiosk further comprises an input device for interacting with said operator interface.

21. The retail sales apparatus of claim 20., wherein said input device is a touch screen device.

22. The retail sales apparatus of claim 21, wherein said touch screen device is integral with said display.

23. A device comprising a touch screen display and an operator interface system, comprising:
a start screen having fewer than five start screen buttons;
a store map screen linked to one of the start screen buttons, wherein said store map screen comprises a store layout and map department buttons integrated into the store layout;
a products screen linked to one of the start screen buttons, said products screen having a department listing button and a sale item listing button; and
a store services screen linked to one of the start screen buttons, said store services screen having one or more service description screen buttons.

24. The device of claim 23, wherein said operator interface system further comprises a department listing screen linked to the department listing button of said products screen, wherein said department listing screen comprises a plurality of store department buttons

25. The device of claim 24, wherein said operator interface system further comprises a category listing screen for each of the store department buttons, wherein said category listing screen comprises a plurality of category buttons and a plurality of navigation buttons.

26. The device of claim 25, wherein said operator interface system further comprises a product listing screen for each of the category buttons, wherein said product listing screen comprises a plurality of manufacturer buttons and a product button list having a plurality of specific product buttons.

27. The device of claim 26, wherein said operator interface system further comprises a product detail screen for each of the specific product buttons, said product detail screen comprising a description of a product, a plurality of navigation buttons, and a shopping list button.

28. The device of claim 23, wherein said touch screen display is integrated into a hand-held device.

29. The device of claim 23, wherein said touch screen display is affixed to a shopping cart.

30. A sales support system, comprising:
a database of at least two sets of manufacturers' products wherein each of the sets of products has a plurality of product sheets;
a server having access to said database, said server being capable of supporting at least one network connection; and
a kiosk disposed at a retail sales outlet and networked with said server, said kiosk having a user interface, comprising:
a start screen having no more than five start screen buttons, wherein the start screen buttons are chosen from a group of buttons consisting of a start screen map button, a start screen products button, a start screen store services button, and a start screen reset button;
a store map screen linked to one of the start screen buttons, wherein said store map comprises a store layout and map department buttons integrated into the store layout;
a products screen linked to one of the start screen buttons, said products screen having a department listing button and a sale item listing button; and
a store services screen linked to one of the start screen buttons, said store services screen having one or more service description screen buttons.

31. The sales support system of claim 30, wherein said user interface further comprises a department listing screen linked to the department listing button of said products screen, wherein said department listing screen comprises a plurality of store department buttons

32. The sales support system of claim 31, wherein said user interface further comprises a category listing screen for each of the store department buttons, wherein said category listing screen comprises a plurality of category buttons and a plurality of navigation buttons.

33. The sales support system of claim 32, wherein said user interface further comprises a product listing screen for each of the category buttons, wherein said product listing screen comprises a plurality of manufacturer buttons and a product button list.

34. The sales support system of claim 33, wherein the product button list comprises a plurality of specific product buttons and wherein each of the product buttons links to one of the product sheets.
